(19) United States
(12) Patent Application Publication
(10) Pub. No.: US 2014/0307446 A1
(43) Pub. Date: Oct. 16, 2014

(54) Light Emitting Diode Lamp

(71) Applicant: UPEC ELECTRONICS CORP., New Taipei City (TW)

(72) Inventor: Huang-Chen GUO, New Taipei City (TW)

(73) Assignee: UPEC ELECTRONICS CORP., New Taipei City (TW)

(21) Appl. No.: 13/862,174

(22) Filed: Apr. 12, 2013

(51) Int. Cl. F21K 99/00

(52) U.S. Cl. CPC F21K 9/50
USPC 362/311.02

(57) ABSTRACT

A light emitting diode lamp comprises a power supply, a lampshade, a light emitting diode circuit board, and an optical filter. The power supply has a housing and a power circuit board, wherein a conductive adhesive is mounted in the housing, and the power circuit board is embedded in the conductive adhesive. The lampshade is connected with the power supply, and the light emitting diode circuit board is coupled with the power circuit board and is mounted in the lampshade. The optical filter is mounted in the lampshade and is located below the light emitting diode circuit.

### BACKGROUND OF THE INVENTION

1. Field of the Invention

The present invention relates to a lamp, especially for a light emitting diode lamp.

2. Description of the Related Art

Conventionally, a light emitting diode lamp generally comprises a power supply, a metal board, a lampshade, and a light emitting diode circuit mounted in the lampshade. The power supply includes a housing and a power circuit mounted in the housing, and the power circuit is coupled with the light emitting diode circuit to provide power to the light emitting diode circuit. The metal is fixed with the lower end of the housing of the power supply and the top end of the lampshade. The power circuit can provide power to the light emitting diode circuit but also generates thermal energy simultaneously. The thermal energy generated by the power supply is conducted to the housing downward. The light emitting diode circuit can transmit light and cause thermal energy simultaneously. The thermal energy produced by the light emitting diode circuit is conducted to the lampshade downward.

However, because the thermal energy produced by the power supply is conducted downward, it will be conducted to the light emitting diode circuit to reduce the life of the light emitting diode lamp and the luminescence efficiency of the light emitting diode lamp. There is a need for a design that can promote the life and the luminescence efficiency of the light emitting diode lamp.

### SUMMARY

The present application provides a light emitting diode lamp. In one embodiment, the light emitting diode lamp comprises a power supply, a lampshade, a light emitting diode circuit board, and an optical filter. The power supply can include a housing and a power circuit board, a conductive adhesive is mounted in the housing, and the power circuit board is embedded in the conductive adhesive. The lampshade is connected with the power supply. The light emitting diode circuit board is coupled with the power circuit board and is mounted in the lampshade. The optical filter is mounted in the lampshade and is located below the light emitting diode circuit board.

### BRIEF DESCRIPTION OF THE DRAWINGS

FIG. 1 is an exploded view illustrating an embodiment of a light emitting diode lamp;

FIG. 2 is a perspective view illustrating a power supply of the light emitting diode lamp;

FIG. 3 is a side view of the light emitting diode lamp;

FIG. 4 is a partial cross-sectional view of FIG. 3 along the A-A line;

FIG. 5 is a top view of the light emitting diode lamp; and

FIG. 6 is a bottom view of the light emitting diode lamp.

### DETAILED DESCRIPTION OF THE EMBODIMENTS

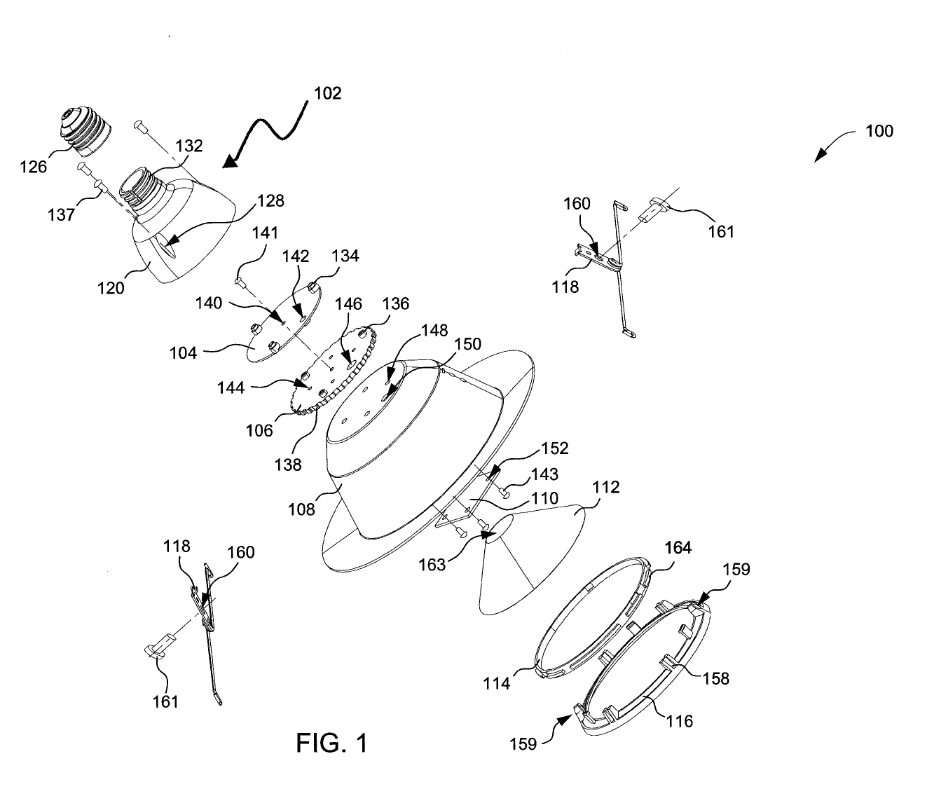

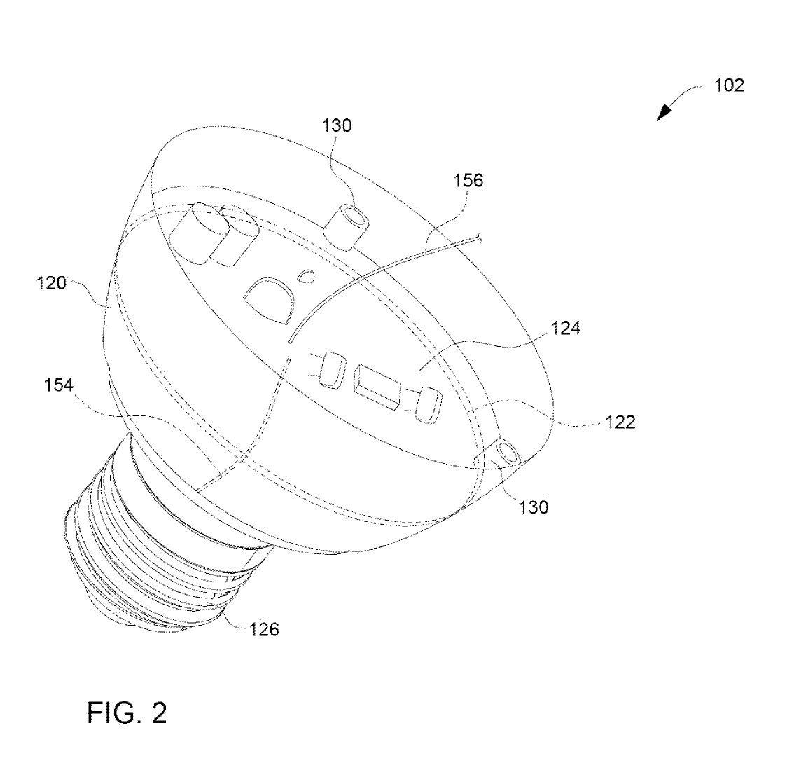

FIG. 1 is an exploded view illustrating an embodiment of a light emitting diode lamp 100. As shown in FIG. 1, the emitting diode lamp 100 comprises a power supply 102 (not shown), an insulating device 104, a fastener 106, a lampshade 108, a light emitting diode circuit board 110, a funneled reflecting device 112, an optical filter 114, a fixing ring 116, and a pair of torsion members 118. In conjunction with FIG. 1, FIG. 2 is a perspective view illustrating the power supply 102 of the light emitting diode lamp 100. The power supply 102 has a housing 120, a power circuit board 122, a conductive adhesive 124, and an electrical joint 126. The conductive adhesive 124 is mounted in the housing 120, and the power circuit board 122 is embedded in the conductive adhesive 124. Because the heat conductivity of the conductive adhesive 124 is higher than the heat conductivity of the housing 120, the heat generated by the power circuit board 122 is transmitted through the conductive adhesive 124. Moreover, several first holes 128 are mounted at the external surface of the housing 120, several first sleeves 130 are protruded from an inside wall of the housing 120, and the first holes 128 are communicated with the first sleeves 130 respectively. An outside surface of an upper end 132 of the housing 120 has a thread structure, and an inside surface of the electrical joint 126 has another thread structure which corresponds to the thread structure of the upper end 132 of the housing 120, such that the electrical joint 126 can be engaged with the upper end 132 of the housing 120.

Several second sleeves 134 are protruded from a top surface of the insulating device 104, several third sleeves 136 are protruded from a top surface of the fastener 106, and the surrounding of the fastener 106 has several teeth 138. The second sleeves 134 are passed through the first sleeves 130 respectively, and the third sleeves 136 are passed through the second sleeves 134 respectively. Moreover, the inside wall of each third sleeve 136 has threads, several screws 137 can be passed through the first holes 128 of the external surface of the housing 120 respectively in a downward direction, and then each screw 137 can be passed through the corresponding first sleeve 130, and the corresponding second sleeve 134, and finally be screwed with the corresponding third sleeve 136, so that the housing 120, the insulating device 104, and the fastener 106 can be fixed together via these screws 137.

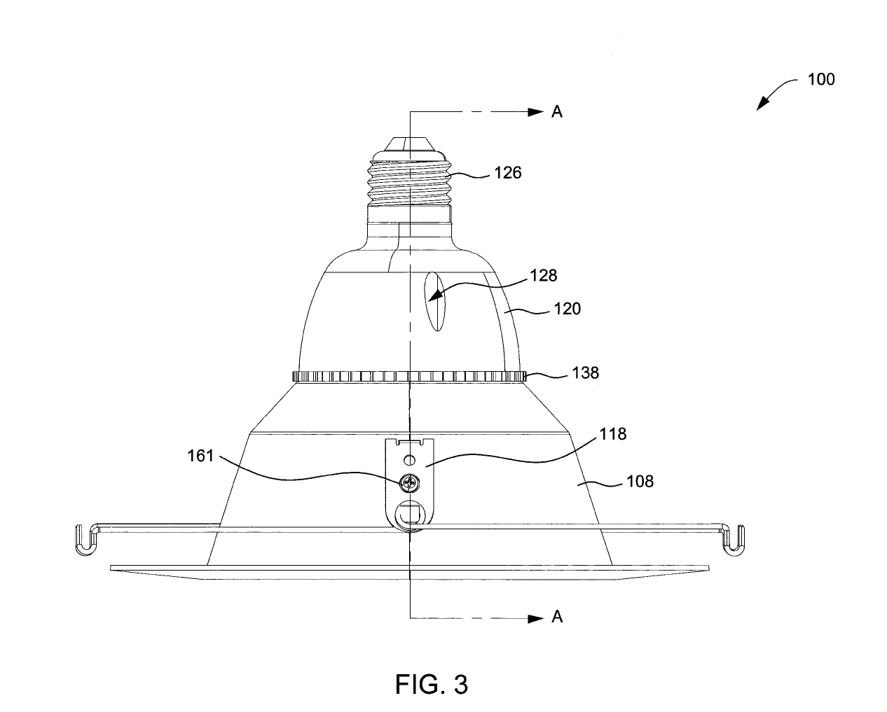

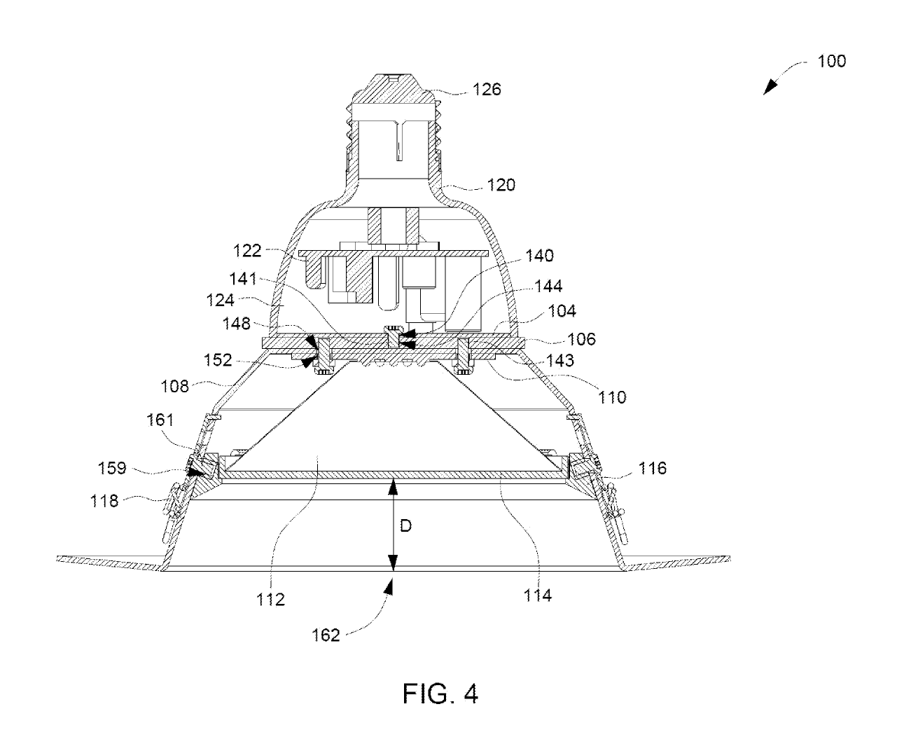

In conjunction with FIG. 1, FIG. 3 is a side view of the light emitting diode lamp 100, and FIG. 4 is a partial cross-sectional view of FIG. 3 along A-A line. One second hole 140 is mounted at the center of the insulating device 104, and one third hole 142 is mounted at the insulating device 104 and the third hole 142 is near the edge of the insulating device 104. The diameter of the third hole 142 is longer than the diameter of the second hole 140. Several fourth holes 144 and one fifth hole 146 are mounted at the fastener 106, several sixth holes 148 and one seventh hole 150 are mounted at a top surface of the lampshade 108, and several eighth holes 152 are mounted at the corners of the light emitting diode circuit board 110. One of the fourth holes 144 of the fastener 106 is aligned with the second hole 140 of the insulating device 104, and a screw 141 can be passed through the fourth hole 144 and the second hole 140 to fix the insulating device 104 with the fastener 106. The other four fourth holes 144 are aligned with the four sixth holes 148 and the four eighth holes 152, and screws 143 can be passed through the fourth holes 144, the sixth holes 148 and the eighth holes 152 to fix the fastener 106 and the light emitting diode circuit board 110 with the lampshade 108.

The power circuit board 122 has a first electric wire 154 and a second electric wire 156 (depicted in FIG. 2), wherein the first electric wire 154 can be extended toward the electrical joint 126 and be coupled with the electrical joint 126, and the second electric wire 156 can be extended toward the insulating device 104 and be traveled through the third hole 142 of the insulating device 104, the fifth hole 146 of the fastener 106, and the seventh hole 150 of the lampshade 108 sequentially to be coupled with the light emitting diode circuit board 110.

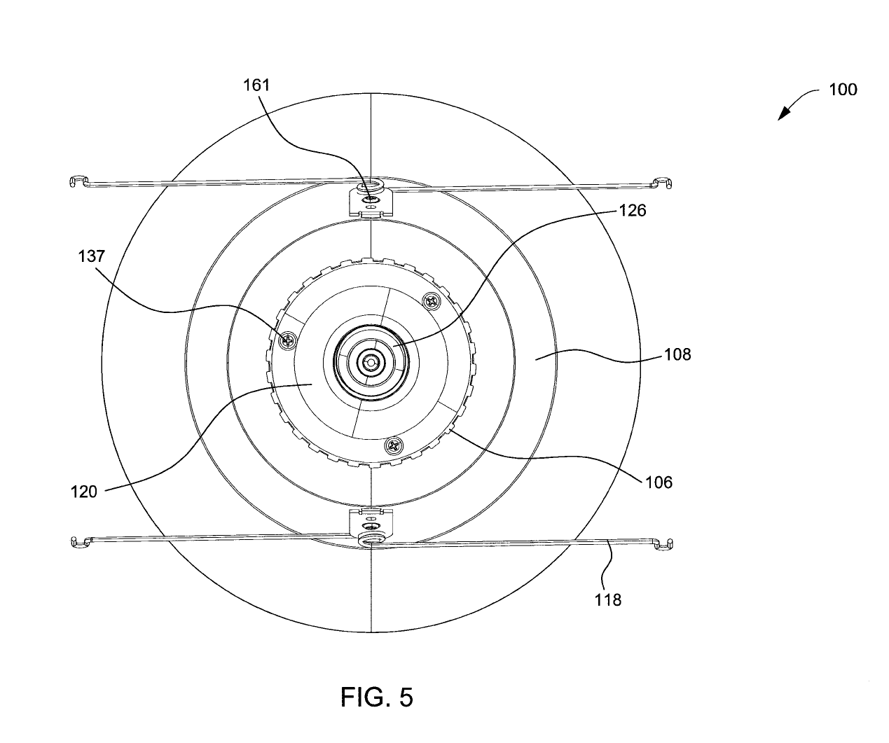

In conjunction with FIG. 1 and FIG. 4, FIG. 5 is a top view of the light emitting diode lamp 100. Several protrusions 158 are extended from the top surface of the fixing ring 116, wherein two of the several protrusions 158 have ninth holes 159 respectively, and each torsion member 118 has a tenth hole 160. Two screws 161 can be passed through the tenth holes 160 of the pair of torsion members 118, the lampshade 108, and the ninth holes 159 of the two protrusions 158 sequentially to fix the fixing ring 116 and the torsion members 118 with the lampshade 108. Wherein the fixing ring 116 is fixed in the interior of the lampshade 108, and the pair of the torsion members 118 symmetrically fixed at the outside of the lampshade 108. The outside of the optical filter 114 has several ribs 164, and the ribs 164 are abutted against the protrusion 158 so that the optical filter 114 is clamped in the inside of the fixing ring 116. A lower end of the lampshade 108 has an opening 162, and the optical filter 114 is located above the opening 162 and there is a desired distance D between the optical filter 114 and the opening 162.

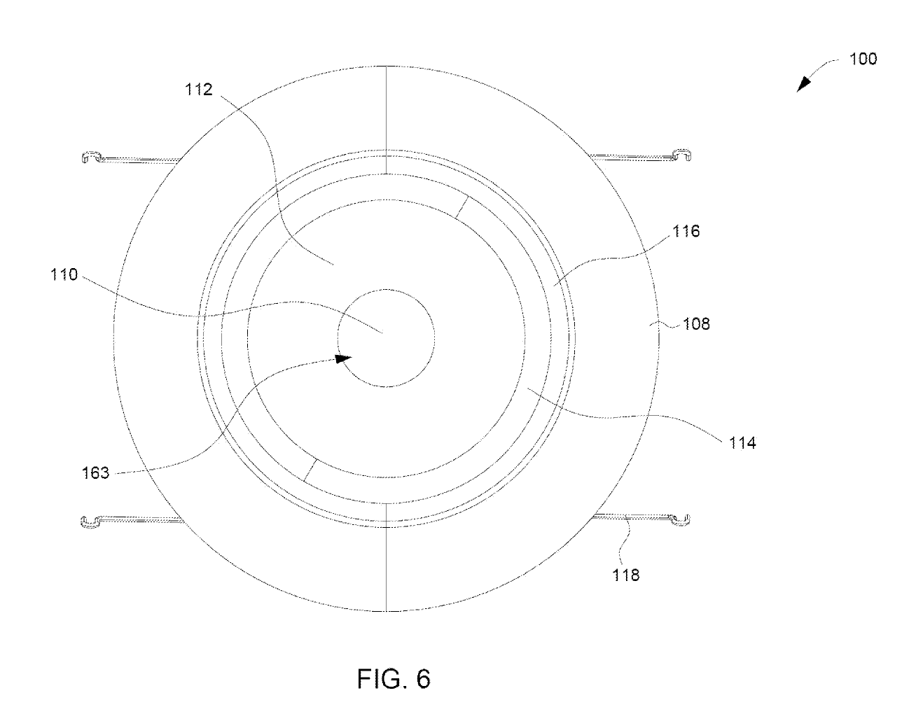

In conjunction with FIG. 4, FIG. 6 is a bottom view of the light emitting diode lamp 100. The funneled reflecting device 112 is made by light-tight material. The height of the funneled reflecting device 112 fits in with a space between the light emitting diode circuit board 110 and the optical filter 114, so the upper end of the funneled reflecting device 112 is abutted against the light emitting diode circuit board 110 and the lower end of the funneled reflecting device 112 is abutted against the optical filter 114. When the light emitting diode circuit board 110 starts to transmit light, the light generated by the light emitting diode circuit board 110 will be passed through an eleventh hole 163 of the funneled reflecting device 112, the optical filter 114, and the opening 162 of the lampshade 108. Because the funneled reflecting device 112 reflects the light and there is a desired distance D between the optical filter 114 and the opening 162, the light becomes more softer.

At least one advantage of the light emitting diode lamp described herein is the ability to increase the life of the light emitting diode lamp and the luminescence efficiency of the light emitting diode lamp. Because the heat conductivity of the conductive adhesive is higher than the heat conductivity of the housing of the power supply, the heat produced by the power circuit board is transmitted through the conductive adhesive and is not conducted to the light emitting diode circuit board, so that the temperature of the light emitting diode circuit board may not be too high, and the life of the light emitting diode lamp and the luminescence efficiency of the light emitting diode lamp can be increased.

Realization of the light emitting diode lamp has been described only in the context of one particular embodiment. The embodiment is meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

What is claimed is:

1. A light emitting diode lamp comprising:
a power supply having a housing and a power circuit board, wherein conductive adhesive is mounted in the housing, and the power circuit board is embedded in the conductive adhesive;
a lampshade connected with the power supply;
a light emitting diode circuit board coupled with the power circuit board and mounted in the lampshade; and
an optical filter mounted in the lampshade and located below the light emitting diode circuit board.

2. The light emitting diode lamp according to claim 1, wherein the power supply includes an electrical joint, and the electrical joint is engaged with an upper end of the housing.

3. The light emitting diode lamp according to claim 1, further comprising a fastener mounted between the power supply and the lampshade.

4. The light emitting diode lamp according to claim 3, wherein a surrounding of the fastener has several teeth

5. The light emitting diode lamp according to claim 3, further comprising an insulating device, the insulating device is fixed with the housing and the fastener.

6. The light emitting diode lamp according to claim 5, wherein at least one first sleeve is protruded from an inside wall of the housing, at least one second sleeve is protruded from a surface of the insulating device, at least one third sleeve is protruded from a surface of the fastener, the at least one second sleeve is passed through the at least one first sleeve, the at least one third sleeve is passed through the at least one second sleeve, and an inside wall of the at least one third sleeve has threads, the at least one first sleeve, the at least one second sleeve and the at least one third sleeve are fixed together via engagements of a screw and the threads.

7. The light emitting diode lamp according to claim 5, wherein the insulating device is located below the power circuit board.

8. The light emitting diode lamp according to claim 1, further comprising a funneled reflecting device mounted in the lampshade and located below the light emitting diode circuit board.

9. The light emitting diode lamp according to claim 8, wherein the funneled reflecting device is made by light-reflective material.

10. The light emitting diode lamp according to claim 8, wherein an upper end of the funneled reflecting device is abutted against the light emitting diode circuit board, and a lowered end of the funneled reflecting device is abutted against the optical filter.

11. The light emitting diode lamp according to claim 1, wherein a lower end of the lampshade has an opening, the optical filter is located above the opening and there is a desired distance between the optical filter and the opening.

12. The light emitting diode lamp according to claim 1, further comprising a fixing ring fixed in the lampshade.

13. The light emitting diode lamp according to claim 12, wherein the optical filter is clamped in an inside of the fixing ring.

14. The light emitting diode lamp according to claim 13, wherein an outside of the optical filter has a plurality of ribs, a top surface of the fixing ring has a plurality of protrusions, wherein each of the ribs are abutted against a corresponding protrusion.

15. The light emitting diode lamp according to claim 12, further comprising a pair of torsion members, and the pair of torsion members are fixed with an outside of the lampshade and the fixing ring.
